(19) United States
(12) Patent Application Publication
(10) Pub. No.: US 2010/0190673 A1
(43) Pub. Date: Jul. 29, 2010

(54) ENCAPSULATES

(76) Inventors: Johan Smets, Lubbeek (BE); Ramanan Venkata Ganapathysundaram, Blue Ash, OH (US); Susana Fernandez Prieto, Benicarlo (ES); Giulia Ottavia Bianchetti, Rome (IT); Mary Jane Combs, Covington, KY (US); Sandra Jacqueline Guinebretiere, Appleton, WI (US); Peggy Dorothy Sands, Appleton, WI (US); Marc Francois Theophile Evers, Strombeek-Bever (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/425,515

(22) Filed: Apr. 17, 2009

Related U.S. Application Data
(63) Continuation-in-part of application No. 12/361,938, filed on Jan. 29, 2009.

(51) Int. Cl. C11D 3/50; C11D 17/08

(52) U.S. Cl. 510/103; 512/4; 510/418; 510/337

(57) ABSTRACT

Encapsulates, compositions, packaged products and displays comprising such encapsulates, and processes for making and using such encapsulates, compositions, packaged products and displays. Such compositions have improved deposition and retention properties that may impart improved benefit characteristics to a composition and/or situs.

### CROSS-REFERENCES TO RELATED APPLICATIONS

This application is a continuation-in-part of and claims priority under 35 U.S.C. §120 to U.S. patent application Ser. No. 12/361,938 filed Jan. 29, 2009.

### FIELD OF INVENTION

The present application relates to encapsulates, compositions, products comprising such encapsulates, and processes for making and using such encapsulates.

### BACKGROUND OF THE INVENTION

Benefit agents, such as a perfumes, dyes, optical brighteners, fabric care agents, bleaching agents, metal catalysts, bleach boosters, solvents, enzymes, insect repellants, silicones, waxes, flavors, vitamins, cooling agents, and skin care agents are expensive and may be less effective when employed at high levels in compositions such as personal care compositions, cleaning compositions, and fabric care compositions. As a result, there is a desire to maximize the effectiveness of such benefit agents. One manner of achieving such objective is to improve the delivery efficiencies of such benefit agents. Unfortunately, it is difficult to improve the delivery efficiencies of benefit agents as such agents may be lost do to the agents' physical or chemical characteristics, such agents may be incompatible with other compositional components or the situs that is treated, or such agents may be lost during post application processes such as rinsing or drying.

One method of improving the delivery efficiency of a benefit agent is to encapsulate so that the agent is only released, for example by fracturing the shell of the encapsulate, when the benefit agent is desired. However, in fluid compositions the aforementioned encapsulate may congregate in certain fluid regions such as the bottom or surface of the fluid. In such cases, the dose of encapsulate that is obtained when the fluid is dispensed may be drastically to high or to low. Thus, the desired effectiveness of the benefit is not obtained.

Accordingly, there is a need for an encapsulate that provides improved benefit agent delivery efficiency in fluids. While not being bound by theory, applicants believe that the encapsulates that are disclosed herein meet such need as such encapsulates are tailored such that they do not congregate in certain regions of a fluid.

### SUMMARY OF THE INVENTION

Encapsulates, compositions, packaged products and displays comprising such encapsulates, and processes for making and using such encapsulates, compositions, packaged products and displays are disclosed. Such encapsulates comprise a core comprising a benefit agent and a shell that at least partially surrounds said core, such encapsulates further comprise a density balancing agent.

### DETAILED DESCRIPTION OF THE INVENTION

### Definitions

As used herein “consumer product” means baby care, beauty care, fabric & home care, family care, feminine care, health care, snack and/or beverage products or devices intended to be used or consumed in the form in which it is sold, and not intended for subsequent commercial manufacture or modification. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals, pet health and nutrition, and water purification; processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); and coffee.

As used herein, the term “cleaning and/or treatment composition” includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners; hair shampoos and hair-rinses; shower gels and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists.

As used herein, the term “fabric care composition” includes, unless otherwise indicated, fabric softening compositions, fabric enhancing compositions, fabric freshening compositions and combinations there of.

As used herein, the articles “a” and “an” when used in a claim, are understood to mean one or more of what is claimed or described.

As used herein, the terms “include”, “includes” and “including” are meant to be synonymous with the phrase “including but not limited to”.

As used herein, the term “solid” includes granular, powder, bar and tablet product forms.

As used herein, the term “situs” includes paper products, fabrics, garments, hard surfaces, hair and skin.

The test methods disclosed in the Test Methods Section of the present application should be used to determine the respective values of the parameters of Applicants' inventions.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Encapsulates

In one aspect, an encapsulate comprising a core comprising a benefit agent and a shell that at least encapsulates said core, said encapsulate further comprising a density balancing agent, such as Table 1 density balancing agent is disclosed.

In one aspect, said encapsulate's benefit agent is selected from the group consisting of a perfume, a dye, optical brightener, fabric care agent, bleaching agent, metal catalyst, bleach booster, solvents, enzyme and mixtures thereof.

In one aspect, said encapsulate's density balancing agent is selected from the group consisting of an organic material having a density greater than about 1, an inorganic oxide, inorganic oxy-chloride, inorganic halogenide, a salt, and mixtures thereof; preferably said organic material is selected from the group consisting of Table 1 Density Balancing Agents; preferably said salt is selected from a hydroxide salt, a carbonate salt and mixtures thereof; preferably said inorganic oxide comprises titanium oxide.

In one aspect, said encapsulate's shell comprises a polymeric water insoluble material selected from the group consisting of polyethylenes, polyamides, polystyrenes, polyisoprenes, polycarbonates, polyesters, polyacrylates, polyureas, polyurethanes, polyolefins, polysaccharides, epoxy resins, vinyl polymers and mixtures thereof, preferably polymerized/polycondensed melamine and formaldehyde.

In one aspect, said encapsulate may have a density of from about 0.8 to about 1.2; from about 0.9 to about 1.1; from about 0.97 to about 1.1.

In one aspect, at least a portion of said density balancing agent is contained in said encapsulate's shell.

In one aspect, said encapsulate's core comprises at least a portion of said density balancing agent.

In one aspect, said encapsulate is a perfume microcapsule.

### Useful Density Balancing Agents

TABLE 1
Density Balancing Agents Useful For Balancing Encapsulates Having Cores With a
Density of Less Than 1

| | | | | Specific |
|---|---|---|---|---|
| | | | | Gravity |
| | CAS | | | 25° C. |
| Item | Number | Registry Name | Trade name | (g/cm³) |
| 1 | 116-66-5 | 1h-indene, 2,3-dihydro-1,1,3,3,5- | moskene | solid |
| | | pentamethyl-4,6-dinitro- | | |
| 2 | 103-64-0 | benzene, (2-bromoethenyl)- | beta-bromstyrol | 1.3898 |
| 3 | 120-24-1 | benzeneacetic acid, 2-methoxy-4-(1- | isoeugenyl phenylacetate | solid |
| | | propenyl)phenyl ester | | |
| 4 | 2530-10-1 | ethanone, 1-(2,5-dimethyl-3- | 3-acetyl-2,5- | 1.1783 |
| | | thienyl)- | dimeththiiophene | |
| 5 | 16546- | oxiranecarboxylic acid, 3-(4- | methoxy ethyl phenyl | solid |
| | 01-3 | methoxyphenyl)-, ethyl ester | glycidate | |
| 6 | 144761- | benzoic acid, 2-[(1-hydroxy-3- | trifone | solid |
| | 91-1 | phenylbutyl)amino]-, methyl ester | | |
| 7 | 6951-08-2 | 1,3-benzodioxole-5-carboxylic acid, | ethyl piperonylate | 1.2430 |
| | | ethyl ester | | |
| 8 | 94-59-7 | 1,3-benzodioxole, 5-(2-propenyl)- | safrole | 1.1280 |
| 9 | 100-09-4 | benzoic acid, 4-methoxy- | p-anisic acid | solid |
| 10 | 90-17-5 | benzenemethanol, .alpha.- | trichloromethyl phenyl | solid |
| | | (trichloromethyl)-, acetate | carbinyl acetate | |
| 11 | 10031- | phenol, 2-methoxy-4-(2-propenyl)-, | eugenyl formate | solid |
| | 96-6 | formate | | |
| 12 | 531-26-0 | phenol, 2-methoxy-4-(2-propenyl)-, | eugenyl benzoate | solid |
| | | benzoate | | |
| 13 | 5320-75-2 | 2-propen-1-ol, 3-phenyl-, benzoate | cinnamyl benzoate | solid |
| 14 | 122-27-0 | benzeneacetic acid, 3-methylphenyl | m-cresyl phenylacetate | solid |
| | | ester | | |
| 15 | 145-39-1 | benzene, 1-(1,1-dimethylethyl)- | musk tibetine | solid |
| | | 3,4,5-trimethyl-2,6-dinitro- | | |
| 16 | 101-94-0 | benzeneacetic acid, 4-methylphenyl | p-tolyl phenylacetate | solid |
| | | ester | | |
| 17 | 102-16-9 | benzeneacetic acid, phenylmethyl | benzyl phenylacetate | solid |
| | | ester | | |
| 18 | 102-17-0 | benzeneacetic acid, (4- | anisyl phenylacetate | solid |
| | | methoxyphenyl)methyl ester | | |
| 19 | 103-41-3 | 2-propenoic acid, 3-phenyl-, | benzyl cinnamate | solid |
| | | phenylmethyl ester | | |
| 20 | 103-53-7 | 2-propenoic acid, 3-phenyl-, 2- | phenethyl cinnamate | solid |
| | | phenylethyl ester | | |
| 21 | 10402- | benzeneacetic acid, 2-methoxy-4-(2- | eugenyl phenylacetate | solid |
| | 33-2 | propenyl)phenyl ester | | |
| 22 | 1073-29-6 | phenol, 2-(methylthio)- | 0-(methylthio)-phenol | solid |
| 23 | 111753- | benzoic acid, 2-[[3-(1,3- | corps oranger 2 | solid |
| | 60-7 | benzodioxol-5-yl)-2- | | |
| | | methylpropylidene]amino]-, methyl | | |
| | | ester | | |
| 24 | 111753- | benzoic acid, 2-[[3-(4- | methyl anthranilate/2- | solid |
| | 62-9 | methoxyphenyl)-2- | methyl-3-(4- | |
| | | methylpropylidene]amino]-,methyl | methoxyphenyl)propanal | |
| | | ester | Schiff base | |
| 25 | 1132-21-4 | benzoic acid, 3,5-dimethoxy- | 3,5-dimethoxybenzoic acid | solid |
| 26 | 118-55-8 | benzoic acid, 2-hydroxy-, phenyl | phenyl salicylate | solid |
| | | ester | | |
| 27 | 118-58-1 | benzoic acid, 2-hydroxy-, | benzyl salicylate | solid |
| | | phenylmethyl ester | | |
| 28 | 118-61-6 | benzoic acid, 2-hydroxy-, ethyl ester | ethyl salicylate | solid |
| 29 | 119-36-8 | benzoic acid, 2-hydroxy-, methyl | methyl salicylate | solid |
| | | ester | | |
| 30 | 134-20-3 | benzoic acid, 2-amino-, methyl ester | methyl anthranilate | 1.1873 |
| 31 | 119-53-9 | ethanone, 2-hydroxy-1,2-diphenyl- | benzoin | solid |
| 32 | 120-47-8 | benzoic acid, 4-hydroxy-, ethyl ester | ethyl 4-hydroxybenzoate | solid |
| 33 | 120-51-4 | benzoic acid, phenylmethyl ester | benzyl benzoate | 1.1308 |
| 34 | 120-58-1 | 1,3-benzodioxole, 5-(1-propenyl)- | isosafrol | solid |
| 35 | 120-75-2 | benzothiazole, 2-methyl- | 2-methylbenzothiazole | solid |
| 36 | 1210-35-1 | 5h-dibenzo[a,d]cyclohepten-5-one, | dibenzosuberenone | solid |
| | | 10,11-dihydro- | | |
| 37 | 121-39-1 | oxiranecarboxylic acid, 3-phenyl-, | ethyl 3-phenylglycidate | solid |
| | | ethyl ester | | |
| 38 | 121-98-2 | benzoic acid, 4-methoxy-, methyl | methyl p-anisate | solid |
| | | ester | | |
| 39 | 122-69-0 | 2-propenoic acid, 3-phenyl-, 3- | cinnamyl cinnamate | 1.1210 |
| | | phenyl-2-propenyl ester | | |
| 40 | 122760- | tricyclo[3.3.1.13,7]decan-2-ol, 4- | tricyclo[3.3.1.13,7]decan- | solid |
| | 84-3 | methyl-8-methylene- | 2-ol, 4-methyl-8- | |
| | | | methylene- | |
| 41 | 122760- | tricyclo[3.3.1.13,7]decan-2-ol, 4- | tricyclo[3.3.1.13,7]decan- | solid |
| | 85-4 | methyl-8-methylene-, acetate | 2-ol, 4-methyl-8- | |
| | | | methylene-, acetate | |
| 42 | 131-55-5 | methanone, bis(2,4- | benzophenone-2 | solid |
| | | dihydroxyphenyl)- | | |
| 43 | 131-57-7 | methanone, (2-hydroxy-4- | oxybenzone | solid |
| | | methoxyphenyl)phenyl- | | |
| 44 | 132-64-9 | dibenzofuran | 2,2′-biphenylene oxide | solid |
| 45 | 133-18-6 | benzoic acid, 2-amino-, 2- | phenethyl anthranilate | 1.1752 |
| | | phenylethyl ester | | |
| 46 | 1333-52-4 | ethanone, 1-(naphthalenyl)- | 1-(naphthyl)ethan-1-one | solid |
| 47 | 13678- | furan, 2,2′-[thiobis(methylene)]bis- | 2,2′-(thiodimethylene)- | solid |
| | 67-6 | | difuran | |
| 48 | 139-45-7 | 1,2,3-propanetriol, tripropanoate | glyceryl tripropanoate | 1.1009 |
| 49 | 140-10-3 | 2-propenoic acid, 3-phenyl-, (e)- | trans-cinnamic acid | solid |
| 50 | 14059- | phenol, 4-ethyl-2,6-dimethoxy- | 4-ethyl-2,6- | solid |
| | 92-8 | | dimethoxyphenol | |
| 51 | 14173- | disulfide, methyl phenyl | methyl phenyl disulfide | 1.1776 |
| | 25-2 | | | |
| 52 | 14735- | benzoic acid, 2-[[(4- | methyl anthranilate/anisic | solid |
| | 72-9 | methoxyphenyl)methylene]amino]-, | aldehyde schiff base | |
| | | methyl ester | | |
| 53 | 14737- | 2-propenoic acid, 3-(2- | cis-2-methoxycinnamic | solid |
| | 91-8 | methoxyphenyl)-, (z)- | acid | |
| 54 | 148-24-3 | 8-quinolinol | 8-hydroxyquinoline | solid |
| 55 | 150-60-7 | disulfide, bis(phenylmethyl) | dibenzyl disulfide | solid |
| 56 | 19224- | 1,2-propanediol, dibenzoate | propylene glycol | 1.1686 |
| | 26-1 | | dibenzoate | |
| 57 | 2039-82-9 | benzene, 1-bromo-4-ethenyl- | 4-bromostyrene | 1.3931 |
| 58 | 2050-87-5 | trisulfide, di-2-propenyl | diallyl trisulfide | 1.1346 |
| 59 | 20675- | phenol, 2,6-dimethoxy-4-(1- | 4-propenyl-2,6- | solid |
| | 95-0 | propenyl)-, (e)- | dimethoxyphenol | |
| 60 | 2257-09-2 | benzene, (2-isothiocyanatoethyl)- | phenethyl isothiocyanate | solid |
| 61 | 22717- | benzoic acid, 2-hydroxy-5-methyl-, | methyl-5-methylsalicylate | solid |
| | 57-3 | methyl ester | | |
| 62 | 23654- | 1,2,4-trithiolane, 3,5-dimethyl- | 3,5-dimethyl-1,2,4- | 1.3018 |
| | 92-4 | | trithiolane | |
| 63 | 23747- | propanoic acid, 2-(methyldithio)-, | ethyl 2- | 1.1378 |
| | 43-5 | ethyl ester | (methyldithio)propionate | |
| 64 | 25485- | benzoic acid, 2-hydroxy-, cyclohexyl | cyclohexyl salicylate | solid |
| | 88-5 | ester | | |
| 65 | 25628- | benzoic acid, 2-[(1- | anthranilic acid, n- | solid |
| | 84-6 | oxopropyl)amino]-, methyl ester | propionyl-, methyl ester | |
| 66 | 26486- | ethanethioic acid, s-(4,5-dihydro-2- | 2-methyl-3-thioacetoxy- | solid |
| | 14-6 | methyl-3-furanyl) ester | 4,5-dihydrofuran | |
| 67 | 2719-08-6 | benzoic acid, 2-(acetylamino)-, | n-acetyl methyl | solid |
| | | methyl ester | anthranilate | |
| 68 | 2765-04-0 | 1,3,5-trithiane, 2,4,6-trimethyl- | 2,4,6-trimethyl-1,3,5- | solid |
| | | | trithiane | |
| 69 | 30954- | benzoic acid, 2-amino-, propyl ester | propyl anthranilate | solid |
| | 98-4 | | | |
| 70 | 3121-70-8 | butanoic acid, 1-naphthalenyl ester | alpha-naphthyl butyrate | solid |
| 71 | 33662- | benzoic acid, 2,4-dihydroxy-3- | methyl 3-methylresorcylate | solid |
| | 58-7 | methyl-, methyl ester | | |
| 72 | 34135- | trisulfide, methyl 2-propenyl | allyl methyl trisulfide | 1.1884 |
| | 85-8 | | | |
| 73 | 34171- | 2-furanmethanol, benzoate | furfuryl benzoate | solid |
| | 46-5 | | | |
| 74 | 34265- | benzoic acid, 2-hydroxy-5-methyl-, | ethyl-5-methylsalicylate | solid |
| | 58-2 | ethyl ester | | |
| 75 | 3591-42-2 | benzene, (2,2-dichloro-1- | 1,1-dichloro-2-methyl-2- | solid |
| | | methylcyclopropyl)- | phenylcyclopropane | |
| 76 | 36880- | 2-thiophenecarboxaldehyde, 5-ethyl- | 5-ethyl-2- | solid |
| | 33-8 | | thiophenecarbaldehyde | |
| 77 | 37837- | benzoic acid, | methyl n-benzylidene-2- | solid |
| | 44-8 | [(phenylmethylene)amino]-, methyl | aminobenzoate | |
| | | ester | | |
| 78 | 38325- | spiro[1,3-dithiolo[4,5-b]furan- | spiro(2,4-dithia-1-methyl- | solid |
| | 25-6 | 2,3′(2′h)-furan], hexahydro-2′,3a- | 8-oxabicyclo[3.3.0]octane- | |
| | | dimethyl- | 3,3′) | |
| 79 | 40527- | 1,3-benzodioxole, 5- | heliotropine diethyl acetal | solid |
| | 42-2 | (diethoxymethyl)- | | |
| 80 | 40785- | cyclododeca[c]furan, | 14-oxabicyclo[10.3.0]-2- | solid |
| | 62-4 | 1,3,3a,4,5,6,7,8,9,10,11,13a- | pentadecene | |
| | | dodecahydro- | | |
| 81 | 4112-89-4 | benzeneacetic acid, 2- | guaiacyl phenylacetate | solid |
| | | methoxyphenyl ester | | |
| 82 | 4265-16-1 | 2-benzofurancarboxaldehyde | 2- | solid |
| | | | benzofurancarboxaldehyde | |
| 83 | 43040- | 1,2,4-trithiane, 3-methyl- | 3-methyl-1,2,4-trithiane | solid |
| | 01-3 | | | |
| 84 | 4437-20-1 | furan, 2,2′-[dithiobis(methylene)]bis- | 2,2′- | 1.3144 |
| | | | (dithiomethylene)difuran | |
| 85 | 458-37-7 | 1,6-heptadiene-3,5-dione, 1,7-bis(4- | curcumin | solid |
| | | hydroxy-3-methoxyphenyl)-, (e,e)- | | |
| 86 | 4707-47-5 | benzoic acid, 2,4-dihydroxy-3,6- | methyl 2,4-dihydroxy-3,6- | solid |
| | | dimethyl-, methyl ester | dimethylbenzoate | |
| 87 | 5446-02-6 | benzoic acid, 2-hydroxy-4-methoxy-, | methyl 4-methoxysalicylate | solid |
| | | methyl ester | | |
| 88 | 5461-08-5 | propanoic acid, 2-methyl-, 1,3- | piperonyl isobutyrate | solid |
| | | benzodioxol-5-ylmethyl ester | | |
| 89 | 54644- | 1,2,4-trithiolane, 3,5-diethyl- | 3,5-diethyl-1,2,4- | solid |
| | 28-9 | | trithiolane | |
| 90 | 54934- | 1,2,4-trithiolane, 3,5-bis(1- | 3,5-diisopropyl-1,2,4- | solid |
| | 99-5 | methylethyl)- | trithiolane | |
| 91 | 57500- | furan, 2-[(methyldithio)methyl]- | methyl furfuryl disulfide | 1.2240 |
| | 00-2 | | | |
| 92 | 5756-24-1 | tetrasulfide, dimethyl | dimethyl tetrasulfide | 1.4180 |
| 93 | 57568- | benzeneacetaldehyde, .alpha.-(2- | 2-phenyl-3-(2-furyl)prop-2- | solid |
| | 60-2 | furanylmethylene)- | enal | |
| 94 | 586-38-9 | benzoic acid, 3-methoxy- | 3-methoxybenzoic acid | solid |
| 95 | 5925-68-8 | benzenecarbothioic acid, s-methyl | s-ethyl benzothioate | 1.1179 |
| | | ester | | |
| 96 | 606-45-1 | benzoic acid, 2-methoxy-, methyl | methyl o-methoxybenzoate | 1.1331 |
| | | ester | | |
| 97 | 607-88-5 | benzoic acid, 2-hydroxy-, 4- | p-cresyl salicylate | solid |
| | | methylphenyl ester | | |
| 98 | 607-90-9 | benzoic acid, 2-hydroxy-, propyl | propyl salicylate | solid |
| | | ester | | |
| 99 | 6099-03-2 | 2-propenoic acid, 3-(2- | 2-methoxycinnamic acid | solid |
| | | methoxyphenyl)- | | |
| 100 | 6099-04-3 | 2-propenoic acid, 3-(3- | 3-methoxycinnamic acid | solid |
| | | methoxyphenyl)- | | |
| 101 | 6110-36-7 | benzoic acid, 2-hydroxy-4-methoxy- | 2-hydroxy-4-methoxy-6- | solid |
| | | 6-methyl-, ethyl ester | methylbenzoic acid, ethyl | |
| | | | ester | |
| 102 | 613-84-3 | benzaldehyde, 2-hydroxy-5-methyl- | 5-methyl salicylic aldehyde | solid |
| 103 | 614-33-5 | 1,2,3-propanetriol, tribenzoate | glyceryl tribenzoate | solid |
| 104 | 614-34-6 | benzoic acid, 4-methylphenyl ester | p-cresyl benzoate | solid |
| 105 | 615-10-1 | 2-furancarboxylic acid, propyl ester | propyl 2-furoate | 1.1128 |
| 106 | 617-01-6 | benzoic acid, 2-hydroxy-, 2- | o-tolyl salicylate | solid |
| | | methylphenyl ester | | |
| 107 | 617-05-0 | benzoic acid, 4-hydroxy-3-methoxy-, | ethyl vanillate | solid |
| | | ethyl ester | | |
| 108 | 621-82-9 | 2-propenoic acid, 3-phenyl- | cinnamic acid | solid |
| 109 | 62265- | benzene, 1,3-dibromo-2-methoxy-4- | 1,3-dibromo-2-methoxy-4- | solid |
| | 99-0 | methyl-5-nitro- | methyl-5-nitrobenzene | |
| 110 | 622-78-6 | benzene, (isothiocyanatomethyl)- | benzyl isothiocyanate | 1.2200 |
| 111 | 623-20-1 | 2-propenoic acid, 3-(2-furanyl)-, | ethyl 3-(2-furyl)-acrylate | 1.1304 |
| | | ethyl ester | | |
| 112 | 6258-60-2 | benzenemethanethiol, 4-methoxy- | p-methoxy benzyl | 1.1108 |
| | | | mercaptan | |
| 113 | 6258-63-5 | 2-thiophenemethanethiol | thenyl mercaptan | 1.1871 |
| 114 | 65416- | benzene, 1,1′-[(2- | phenylacetaldehyde | solid |
| | 19-5 | phenylethylidene)bis(oxymethylene)]bis- | dibenzyl acetal | |
| 115 | 6627-88-9 | phenol, 2,6-dimethoxy-4-(2- | 4-allyl-2,6- | solid |
| | | propenyl)- | dimethoxyphenol | |
| 116 | 67785- | benzoic acid, 2-[(2- | methyl | solid |
| | 76-6 | phenylethylidene)amino]-, methyl | anthranilate/phenylacetalde | |
| | | ester | hyde Schiff base | |
| 117 | 67801- | benzenepropanoic acid, .beta.-oxo-, | p-tolyl 3-oxo-3- | solid |
| | 43-8 | 4-methylphenyl ester | phenylpropionate | |
| 118 | 67860- | 1h-indole-3-heptanol, .eta.-1h-indol- | indolene | solid |
| | 00-8 | 3-yl-.alpha.,.alpha.,.epsilon.- | | |
| | | trimethyl- | | |
| 119 | 68555- | benzoic acid, 2-hydroxy-, 3-methyl- | prenyl salicylate | solid |
| | 58-8 | 2-butenyl ester | | |
| 120 | 68844- | 1,3-benzodioxole-5-propanol, | alpha-methyl-1,3- | solid |
| | 96-2 | .alpha.-methyl-, acetate | benzodioxole-5-propanol, | |
| | | | acetate | |
| 121 | 6911-51-9 | thiophene, 2,2′-dithiobis- | 2-thienyl disulfide | solid |
| 122 | 69-72-7 | benzoic acid, 2-hydroxy- | salicylic acid | solid |
| 123 | 698-27-1 | benzaldehyde, 2-hydroxy-4-methyl- | 2-hydroxy-4- | solid |
| | | | methylbenzaldehyde | |
| 124 | 699-10-5 | disulfide, methyl phenylmethyl | methyl benzyl disulfide | 1.1382 |
| 125 | 7149-32-8 | 2-furancarboxylic acid, 2- | phenethyl 2-furoate | 1.1891 |
| | | phenylethyl ester | | |
| 126 | 7217-59-6 | benzenethiol, 2-methoxy- | 2-methoxy-thiophenol | 1.1530 |
| 127 | 72927- | benzoic acid, 2-[[(4-hydroxy-3- | benzoic acid, 2-[[(4- | solid |
| | 84-5 | methoxyphenyl)methylene]amino]-, | hydroxy-3- | |
| | | methyl ester | methoxyphenyl)methylene]amino]-, | |
| | | | methyl ester | |
| 128 | 72987- | ethanol, 2-(4-methylphenoxy)-1-(2- | algix synarome | 1.1309 |
| | 59-8 | phenylethoxy)- | | |
| 129 | 7492-65-1 | benzeneacetic acid, 3-phenyl-2- | cinnamyl phenylacetate | solid |
| | | propenyl ester | | |
| 130 | 7493-63-2 | benzoic acid, 2-amino-, 2-propenyl | allyl anthranilate | solid |
| | | ester | | |
| 131 | 75147- | bicyclo[3.2.1]octan-8-one, 1,5- | 1,5-dimethyl- | solid |
| | 23-8 | dimethyl-, oxime | bicyclo[3.2.1]octan-8-one, | |
| | | | oxime- | |
| 132 | 7774-74-5 | 2-thiophenethiol | 2-thienyl mercaptan | 1.2297 |
| 133 | 7774-96-1 | phenol, 2-methoxy-4-(1-propenyl)-, | isoeugenyl formate | solid |
| | | formate | | |
| 134 | 7779-16-0 | benzoic acid, 2-amino-, cyclohexyl | cyclohexyl anthranilate | solid |
| | | ester | | |
| 135 | 7786-61-0 | phenol, 4-ethenyl-2-methoxy- | 2-methoxy-4-vinylphenol | solid |
| 136 | 79915- | benzoic acid, 2-hydroxy-, 2-(1- | 2-isopropoxyethyl | solid |
| | 74-5 | methylethoxy)ethyl ester | salicylate | |
| 137 | 81-14-1 | ethanone, 1-[4-(1,1-dimethylethyl)- | musk ketone | solid |
| | | 2,6-dimethyl-3,5-dinitrophenyl]- | | |
| 138 | 81-15-2 | benzene, 1-(1,1-dimethylethyl)-3,5- | musk xylol | solid |
| | | dimethyl-2,4,6-trinitro- | | |
| 139 | 830-09-1 | 2-propenoic acid, 3-(4- | 4-methoxycinnamic acid | solid |
| | | methoxyphenyl)- | | |
| 140 | 83-66-9 | benzene, 1-(1,1-dimethylethyl)-2- | musk ambrette | solid |
| | | methoxy-4-methyl-3,5-dinitro- | | |
| 141 | 84-66-2 | 1,2-benzenedicarboxylic acid, | diethyl phthalate | 1.1221 |
| | | diethyl ester | | |
| 142 | 85213- | ethanone, 1-(3,4-dihydro-2h-pyrrol- | 2-acetyl-1-pyrroline | 1.2592 |
| | 22-5 | 5-yl)- | | |
| 143 | 85-91-6 | benzoic acid, 2-(methylamino)-, | dimethyl anthranilate | solid |
| | | methyl ester | | |
| 144 | 87-05-8 | 2h-1-benzopyran-2-one, 7-ethoxy-4- | 4-methyl-7- | solid |
| | | methyl- | ethoxycoumarin | |
| 145 | 87-22-9 | benzoic acid, 2-hydroxy-, 2- | phenethyl salicylate | solid |
| | | phenylethyl ester | | |
| 146 | 87-25-2 | benzoic acid, 2-amino-, ethyl ester | ethyl anthranilate | 1.1408 |
| 147 | 87-29-6 | 2-propen-1-ol, 3-phenyl-, 2- | cinnamyl anthranilate | solid |
| | | aminobenzoate | | |
| 148 | 88-04-0 | phenol, 4-chloro-3,5-dimethyl- | chloroxylenol | solid |
| 149 | 882-33-7 | disulfide, diphenyl | phenyl disulfide | solid |
| 150 | 90-15-3 | 1-naphthalenol | 1-naphthol | solid |
| 151 | 90-43-7 | [1,1′-biphenyl]-2-ol | 2-phenylphenol | solid |
| 152 | 91-01-0 | benzenemethanol, .alpha.-phenyl- | benzohydrol | solid |
| 153 | 91-60-1 | 2-naphthalenethiol | 2-naphthyl mercaptan | solid |
| 154 | 93-08-3 | ethanone, 1-(2-naphthalenyl)- | methyl beta-naphthyl | solid |
| | | | ketone | |
| 155 | 93-29-8 | phenol, 2-methoxy-4-(1-propenyl)-, | isoeugenyl acetate | solid |
| | | acetate | | |
| 156 | 93-44-7 | 2-naphthalenol, benzoate | 2-naphthyl benzoate | solid |
| 157 | 93-99-2 | benzoic acid, phenyl ester | phenyl benzoate | solid |
| 158 | 94022- | pyridine, 2-[3-(2- | pyridine, 2-[3-(2- | solid |
| | 30-7 | chlorophenyl)propyl]- | chlorophenyl)propyl]- | |
| 159 | 94-13-3 | benzoic acid, 4-hydroxy-, propyl | propylparaben | solid |
| | | ester | | |
| 160 | 941-98-0 | ethanone, 1-(1-naphthalenyl)- | methyl 1-naphthyl ketone | solid |
| 161 | 94278- | propanoic acid, 3-[(2- | ethyl 3- | solid |
| | 27-0 | furanylmethyl)thio]-, ethyl ester | (furfurylthio)propionate | |
| 162 | 94-41-7 | 2-propen-1-one, 1,3-diphenyl- | chalcone | solid |
| 163 | 94-44-0 | 3-pyridinecarboxylic acid, | benzyl nicotinate | solid |
| | | phenylmethyl ester | | |
| 164 | 94-47-3 | benzoic acid, 2-phenylethyl ester | phenethyl benzoate | solid |
| 165 | 94-62-2 | piperidine, 1-[5-(1,3-benzodioxol-5- | piperine | solid |
| | | yl)-1-oxo-2,4-pentadienyl]-,(e,e)- | | |
| 166 | 95-16-9 | benzothiazole | benzosulfonazole | 1.1500 |

TABLE 2
Density Balancing Agents Useful For Balancing Encapsulates Having Cores With a
Density of Greater Than 1

| | | | | Specific |
|---|---|---|---|---|
| | | | | Gravity |
| | | | | 25 C. |
| Item | CAS Number | Registry Name | Trade Name | (g/cm³) |
| 1 | 111-66-0 | 1-Octene | Caprylene | 0.7086 |
| 2 | 124-18-5 | Decane | n-Decane | 0.7263 |
| 3 | 1120-21-4 | Undecane | Undecane | 0.7359 |
| 4 | 629-50-5 | Tridecane | Tridecane | 0.7521 |
| 5 | 2436-90-0 | 1,6-Octadiene, 3,7-dimethyl- | Dihydromyrcene | 0.7602 |
| 6 | 4747-07-3 | Hexane, 1-methoxy- | Diola | 0.7610 |
| 7 | 13567-39-0 | 2H-2a,7-Methanoazuleno[5,6-b]oxirene, | Andrane | 0.7691 |
| | | octahydro-3,6,6,7a- | | |
| | | tetramethyl-, [1aS- | | |
| | | (1a.alpha.,2a.beta.,3.alpha.,5a.alpha., | | |
| | | 7.beta.,7a.alpha.)]- | | |
| 8 | 1686-14-2 | 3-Oxatricyclo[4.1.1.02,4]octane, | alpha-Pinene oxide | 0.7706 |
| | | 2,7,7-trimethyl- | | |
| 9 | 1329-99-3 | Cyclohexane, 1-methyl-4-(1- | Phellandrene | 0.7820 |
| | | methylethyl)-, tetradehydro deriv. | | |
| 10 | 1135-66-6 | 2H-2,4a-Methanonaphthalene, | Isolongifolene | 0.7858 |
| | | 1,3,4,5,6,7-hexahydro-1,1,5,5- | | |
| | | tetramethyl-, (2S)- | | |
| 11 | 7289-52-3 | Decane, 1-methoxy- | Decyl methyl ether | 0.7884 |
| 12 | 1119-16-0 | Pentanal, 4-methyl- | 4-Methylpentanal | 0.7944 |
| 13 | 13877-91-3 | 1,3,6-Octatriene, 3,7-dimethyl- | Ocimene | 0.7948 |
| 14 | 66-25-1 | Hexanal | Caproaldehyde | 0.7971 |
| 15 | 22810-10-2 | Octane, 1-ethoxy-3,7-dimethyl- | Citronellyl ethyl ether | 0.7972 |
| 16 | 626-93-7 | 2-Hexanol | 2-Hexanol | 0.8006 |
| 17 | 124-13-0 | Octanal | Caprylic aldehyde | 0.8047 |
| 18 | 124-19-6 | Nonanal | Nonaldehyde | 0.8080 |
| 19 | 1337-83-3 | Undecenal | 8/9/10-Undecenal | 0.8097 |
| | | | (mixture) | |
| 20 | 123-19-3 | 4-Heptanone | Dipropyl ketone | 0.8114 |
| 21 | 628-99-9 | 2-Nonanol | 2-Nonanol | 0.8121 |
| 22 | 112-44-7 | Undecanal | Undecanal | 0.8137 |
| 23 | 10486-19-8 | Tridecanal | Tridecanal | 0.8183 |
| 24 | 53535-33-4 | Heptanol | | 0.8185 |
| 25 | 111-01-3 | Tetracosane, 2,6,10,15,19,23- | Squalane | 0.8196 |
| | | hexamethyl- | | |
| 26 | 97-95-0 | 1-Butanol, 2-ethyl- | 2-Ethyl-1-butanol | 0.8220 |
| 27 | 112-45-8 | 10-Undecenal | Intreleven aldehyde | 0.8236 |
| 28 | 69112-21-6 | 3-Hexenal, (E)- | trans-3-Hexenal | 0.8256 |
| 29 | 106-21-8 | 1-Octanol, 3,7-dimethyl- | Dimethyl Octanol | 0.8256 |
| 30 | 23787-90-8 | 2H-2,4a-Methanonaphthalen- | Piconia | 0.8259 |
| | | 8(5H)-one, 1,3,4,6,7,8a- | | |
| | | hexahydro-1,1,5,5-tetramethyl- | | |
| 31 | 112-53-8 | 1-Dodecanol | Lauryl alcohol | 0.8261 |
| 32 | 78-69-3 | 3-Octanol, 3,7-dimethyl- | Tetrahydrolinalool | 0.8276 |
| 33 | 3391-86-4 | 1-Octen-3-ol | Amyl vinyl carbinol | 0.8283 |
| 34 | 6728-26-3 | 2-Hexenal, (E)- | trans-2-Hexenal (Leaf | 0.8344 |
| | | | Aldehyde) | |
| 35 | 138-86-3 | Cyclohexene, 1-methyl-4-(1- | Limonene | 0.8351 |
| | | methylethenyl)- | | |
| 36 | 108-64-5 | Butanoic acid, 3-methyl-, ethyl | Ethyl isovalerate | 0.8625 |
| | | ester | | |
| 37 | 539-82-2 | Pentanoic acid, ethyl ester | Ethyl valerate | 0.8647 |
| 38 | 7452-79-1 | Butanoic acid, 2-methyl-, ethyl | Ethyl 2-methylbutyrate | 0.8656 |
| | | ester | | |
| 39 | 78-70-6 | 1,6-Octadien-3-ol, 3,7-dimethyl- | Linalool | 0.8669 |
| 40 | 67874-72-0 | Cyclohexanol, 2-(1,1- | 4-tert.Amylcyclohexyl | 0.9199 |
| | | dimethylpropyl)-, acetate | acetate | |
| 41 | 23726-91-2 | 2-Buten-1-one, 1-(2,6,6- | beta-Damascone | 0.9211 |
| | | trimethyl-1-cyclohexen-1-yl)-, | | |
| | | (E)- | | |
| 42 | 107-75-5 | Octanal, 7-hydroxy-3,7-dimethyl- | Hydroxycitronellal | 0.9215 |
| 43 | 698-76-0 | 2H-Pyran-2-one, tetrahydro-6- | delta-Octalactone | 0.9498 |
| | | propyl- | | |
| 44 | 8014-17-3 | Petitgrain absolute France | Petitgrain absolute | 0.8890-0.8990 |
| | | | France | |
| 45 | 8024-08-6 | Violet leaf absolute | Violet leaf absolute | 0.9050-0.9550 |
| 46 | 8030-28-2 | Orangeflower absolute morocco | Orangeflower absolute | 0.9100-0.9600 |
| | | | morocco | |
| 47 | 8007-01-0 | Rose absolute morocco | Rose absolute morocco | 0.9490-0.9890 |
| 48 | 8022-96-6 | Jasmin absolute concrete Egypt | Jasmin absolute concrete | 0.9100-0.9800 |
| | | | Egypt | |
| 49 | 110-27-10 | Myristic acid isopropyl ester | Isopropyl myristate | 0.8500 |

### Process of Making Encapsulates

Methods of making suitable encapsulates as well as suitable shell materials are described in U.S. Pat. No. 6,869,923 B1 and US Published Patent Applications Nos. 2005/0276831 A1 and 2007/020263 A1. Suitable equipment for use in the processes disclosed herein may include continuous stirred tank reactors, homogenizers, turbine agitators, recirculating pumps, paddle mixers, ploughshear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Kentucky, U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

### Compositions Comprising Encapsulates

In one aspect, a composition comprising any aspect of the encapsulated disclosed in the present specification is disclosed.

In one aspect, said composition may comprise one or more fluids, said composition having a settling velocity of less than about 1.5 cm/year, less than about 1.0 cm/year, less than about 0.5 cm/year or even from about 0.1 cm/year to about 0.5 cm/year.

In one aspect, said composition may comprise one or more fluids and having a density such that the density ratio of said encapsulate and at least one of said one or more fluids is from about 0.9:1 to about 1.1:1; from about 0.98:1 to about 1.02:1; from about 0.99:1 to about 1.01:1 or even 1:1.

In one aspect, said composition may comprise an encapsulate wherein said encapsulate's density may be such that the density ratio of said encapsulate to one or more fluids of the composition's fluids may be from about 0.9:1 to about 1.1:1; from about 0.98:1 to about 1.02:1; from about 0.99:1 to about 1.01:1 or even 1:1.

In one aspect, any of the aforementioned compositions may comprise a cleaning and/or treatment ingredient.

In one aspect, any of the aforementioned compositions' encapsulates may be a perfume microcapsule.

In one aspect, any of the aforementioned compositions may comprise a cleaning and/or treatment agent selected from the group consisting of bleaches, bleach precursors, metal catalysts, bleach boosters, peracids, diacyls, enzymes, and mixtures thereof; preferably bleach boosters and bleach precursors and mixtures thereof, more preferably perfume and mixtures thereof.

In one aspect, any composition disclosed herein may be a consumer product. While the precise level of encapsulate that is employed depends on the type and end use of the, consumer product, in one aspect a consumer product may comprise, based on total composition weight, at least about 0.01%, from about 0.01% to about 80%, or even from about 0.02% to about 10% wt % of a encapsulate disclosed herein.

In one aspect, a consumer product that is compact is disclosed.

In one aspect, a consumer products including liquid detergents having a water content, based on total consumer product formulation weight, of from about 0% to about 15%, from about 0.5% to about 10% or even from about 1% to about 8% water are disclosed.

In one aspect, a consumer product comprising at least one embodiment of a encapsulate disclosed herein and a material selected from the group consisting of a surfactant, an enzyme, a polymer, a dye, a neat perfume, a perfume delivery system in addition to Applicants' benefit agent delivery system and mixtures thereof is disclosed. Suitable perfume delivery systems are described in published U.S. Patent Application No. 2007/0275866 A1

In one aspect, the consumer product is a cleaning and/or treatment composition or fabric care composition that may comprise an encapsulate disclosed in the present specification and at least one cleaning and/or treatment composition or fabric care adjunct ingredient.

In one aspect, a cleaning composition may comprise, from about 0.005% to about 5% weight % of such encapsulate based on total cleaning composition weight of such encapsulate. In one aspect, a fabric treatment composition may comprise, based on total fabric treatment composition weight from about 0.005% to about 20% of such encapsulate.

### Rheology Modifier

The compositions of the present invention may comprise a rheology modifier. The rheology modifier may be selected from the group consisting of non-polymeric crystalline, hydroxy-functional materials, polymeric rheology modifiers which impart shear thinning characteristics to the aqueous liquid matrix of the composition. In one aspect, such rheology modifiers impart to the aqueous liquid composition a high shear viscosity, at 20 sec⁻¹ shear rate and at 21° C., of from 1 to 7000 cps and a viscosity at low shear (0.5 sec⁻¹ shear rate at 21° C.) of greater than 1000 cps, or even 1000 cps to 200,000 cps. In one aspect, for cleaning and treatment compositions, such rheology modifiers impart to the aqueous liquid composition a high shear viscosity, at 20 sec⁻¹ and at 21° C., of from 50 to 3000 cps and a viscosity at low shear (0.5 sec⁻¹ shear rate at 21° C.) of greater than 1000 cps, or even 1000 cps to 200,000 cps. Viscosity according to the present invention is measured using an AR 2000 rheometer from TA instruments using a plate steel spindle having a plate diameter of 40 mm and a gap size of 500 μm. The high shear viscosity at 20 sec⁻¹ and low shear viscosity at 0.5 sec⁻¹ can be obtained from a logarithmic shear rate sweep from 0.1 sec⁻¹ to 25 sec⁻¹ in 3 minutes time at 21° C. Crystalline hydroxyl functional materials are rheology modifiers which form thread-like structuring systems throughout the matrix of the composition upon in situ crystallization in the matrix. Polymeric rheology modifiers are preferably selected from polyacrylates, polymeric gums, other non-gum polysaccharides, and combinations of these polymeric materials.

Generally the rheology modifier will comprise from 0.01% to 1% by weight, preferably from 0.05% to 0.75% by weight, more preferably from 0.1% to 0.5% by weight, of the compositions herein.

Structuring agent which are especially useful in the compositions of the present invention comprises non-polymeric (except for conventional alkoxylation), crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes. In one aspect, rheology modifiers include crystalline, hydroxyl-containing rheology modifiers include castor oil and its derivatives. In one aspect, rheology modifiers include may be hydrogenated castor oil derivatives such as hydrogenated castor oil and hydrogenated castor wax. Commercially available, castor oil-based, crystalline, hydroxyl-containing rheology modifiers include THIXCIN™ from Rheox, Inc. (now Elementis).

Other types of rheology modifiers, besides the non-polymeric, crystalline, hydroxyl-containing rheology modifiers described heretofore, may be utilized in the liquid detergent compositions herein. Polymeric materials which provide shear-thinning characteristics to the aqueous liquid matrix may also be employed.

Suitable polymeric rheology modifiers include those of the polyacrylate, polysaccharide or polysaccharide derivative type. Polysaccharide derivatives typically used as rheology modifiers comprise polymeric gum materials. Such gums include pectine, alginate, arabinogalactan (gum Arabic), carrageenan, gellan gum, xanthan gum and guar gum.

If polymeric rheology modifiers are employed herein, a preferred material of this type is gellan gum. Gellan gum is a heteropolysaccharide prepared by fermentation of Pseudomonaselodea ATCC 31461. Gellan gum is commercially marketed by CP Kelco U.S., Inc. under the KELCOGEL tradename.

A further alternative and suitable rheology modifier include a combination of a solvent and a polycarboxylate polymer. More specifically the solvent may be an alkylene glycol. In one aspect, the solvent may compriser dipropylene glycol. In one aspect, the polycarboxylate polymer may comprise a polyacrylate, polymethacrylate or mixtures thereof. In one aspect, solvent may be present, based on total composition weight, at a level of from 0.5% to 15%, or from 2% to 9% of the composition. In one aspect, polycarboxylate polymer may be present, based on total composition weight, at a level of from 0.1% to 10%, or from 2% to 5%. In one aspect, the solvent component may comprise mixture of dipropylene glycol and 1,2-propanediol. In one aspect, the ratio of dipropylene glycol to 1,2-propanediol may be 3:1 to 1:3, or even 1:1. In one aspect, the polyacrylate may comprise a copolymer of unsaturated mono- or di-carbonic acid and C₁-C₃₀ alkyl ester of the (meth) acrylic acid. In another aspect, the rheology modifier may comprise a polyacrylate of unsaturated mono- or di-carbonic acid and C₁-C₃₀ alkyl ester of the (meth)acrylic acid. Such copolymers are available from Noveon Inc under the tradename Carbopol Aqua 30®.

In the absence of rheology modifier and in order to impart the desired shear thinning characteristics to the liquid composition, the liquid composition can be internally structured through surfactant phase chemistry or gel phases.

Aspects of the invention include the use of the encapsulates of the present invention in laundry detergent compositions (e.g., TIDE™), hard surface cleaners (e.g., MR CLEAN™), automatic dishwashing liquids (e.g., CASCADE™), dishwashing liquids (e.g., DAWN™), and floor cleaners (e.g., SWIFFER™). Non-limiting examples of cleaning compositions may include those described in U.S. Pat. Nos. 4,515,705; 4,537,706; 4,537,707; 4,550,862; 4,561,998; 4,597,898; 4,968,451; 5,565,145; 5,929,022; 6,294,514; 6,376,445, 7,169,741 B2 and 7,297,674 B2 as well as in U.S. Patent Application Publication No. 2005/0130864 A1. The cleaning compositions disclosed herein may be formulated such that, during use in aqueous cleaning operations, the wash water will have a pH of between about 6.5 and about 12, or between about 7.5 and 10.5. Liquid dishwashing product formulations typically have a pH between about 6.8 and about 9.0. Cleaning products are typically formulated to have a pH of from about 7 to about 12. Techniques for controlling pH at recommended usage levels include the use of buffers, alkalis, acids, etc., and are well known to those skilled in the art.

Fabric treatment compositions disclosed herein typically comprise a fabric softening active (“FSA”). Suitable fabric softening actives, include, but are not limited to, materials selected from the group consisting of quats, amines, fatty esters, sucrose esters, silicones, dispersible polyolefins, clays, polysaccharides, fatty oils, polymer latexes and mixtures thereof.

### Adjunct Materials

While not essential for each consumer product embodiment of the present invention, the non-limiting list of adjuncts illustrated hereinafter are suitable for use in the instant consumer products and may be desirably incorporated in certain embodiments of the invention, for example to assist or enhance performance, for treatment of the substrate to be cleaned, or to modify the aesthetics of the composition as is the case with perfumes, colorants, dyes or the like. The precise nature of these additional components, and levels of incorporation thereof, will depend on the physical form of the composition and the nature of the operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, thickeners/structurants, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential for each consumer product embodiment of the present invention. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, thickeners/structurants, fabric softeners, carriers, hydrotropes, processing aids and/or pigments. However, when one or more adjuncts is present, such one or more adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Builders—The compositions of the present invention can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methyl-enephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Preferred transition-metals in the instant transition-metal bleach catalyst include manganese, iron and chromium. Preferred MRL's herein are a special type of ultra-rigid ligand that is cross-bridged such as 5,12-diethyl-1,5,8,12-tetraazabicyclo[6.6.2]hexa-decane.

Suitable transition metal MRLs are readily prepared by known procedures, such as taught for example in WO 00/32601, and U.S. Pat. No. 6,225,464.

Suitable thickeners/structurants and useful levels of same are described in U.S. Patent Application Publication No. 2005/0130864 A1 and U.S. Pat. Nos. 7,169,741 B2 and 7,297,674 B2.

### Processes of Making and Using Consumer Products

The embodiments of consumer products of the present invention can be formulated into any suitable form and prepared by any process chosen by the formulator, non-limiting examples of which are described in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use

Compositions, such as consumer products, containing the encapsulate disclosed herein can be used to clean or treat a situs inter alia a surface or fabric. Typically at least a portion of the situs is contacted with an embodiment of Applicants' composition, in neat form or diluted in a liquor, for example, a wash liquor and then the situs may be optionally washed and/or rinsed. In one aspect, a situs is optionally washed and/or rinsed, contacted with a encapsulate according to the present invention or composition comprising said encapsulate and then optionally washed and/or rinsed. For purposes of the present invention, washing includes but is not limited to, scrubbing, and mechanical agitation. The situs may comprise most any material, for example a fabric, fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

### Test Methods

It is understood that the test methods that are disclosed in the Test Methods Section of the present application should be used to determine the respective values of the parameters of Applicants' invention as such invention is described and claimed herein.

### Method For Determining Settling Velocity

1.) Place a 1 kg sample of the product that will be tested in a plastic jar, secure the jar to allow only for vertical movement, and allow the sample to equilibrate for 24 hours at ambient temperature 22° C.±3° C.
2.) Place the sample on the Lansmont Vibration Table, Model 1800-10 and secure to the table.
3.) Test the sample according to ASTM4196, Truck Assurance II.
4.) Remove the sample from the vibration table after completion.
5.) Extract a 60 ml sample from the top and bottom of the sample jar using a disposable pipette.
6.) The “top” and “bottom” aliquots are analyzed for particle size and counts using the Lasentec FBRM Particle Size Analyzer, Model # PI-14/206 and the following
   Lasentec Measurement Configurations:
   Measurement Range: 1000 um
   Channel Grouping: 1-500 um 90 log channel
   Scanning Speed: 2 m/s
   No time averaging
   Measurement Duration: 3 seconds
   Measure approximately 60 ml of product in a beaker, agitated at 400 rpm for 2 minutes minimum while measurements are taken.
7.) For purposes of the present specification, if the particle counts in the test samples' top and bottom have a difference of greater than 20%, the settling velocity of the test product is greater than about 1.5 cm/year, if the particle counts in the test samples' top and bottom have a difference of between about 10% and 20%, then the settling velocity of the test product is between about 1.0 cm/year and about 1.5 cm/year, if the particle counts in the test samples' top and bottom have a difference of between about 8% and 10%, then the settling velocity of the test product is between about 0.5 cm/year and about 1.0 cm/year, if the particle counts in the test samples' top and bottom have a difference of between about 5% and 8%, then the settling velocity of the test product is between about 0.1 cm/year and about 0.5 cm/year.

### Bulk Liquid Detergent Density Measurement

### I. Equipment

A balance with accuracy to 0.001 g should be used.
Specific gravity cups made by the Paul N. Gardner Co., model # WG-SS-83.2/C. Each stainless steel cup has been calibrated to meet MIL STD 45662A and has an accompanying certificate. Such cups have a volume of 83.2 ml.

### II Test Procedure

1.) Place the specific gravity cup and lid on the balance and tare the balance.
2.) Remove the cup and lid from the balance and fill with 83.2 ml of desired product (i.e. liquid detergent). The inside of the lid is concave so make sure there is enough product to completely fill the cup.
3.) To determine if the cup is full, place the lid on the cup to make a complete seal. Product may flow out of the hole in the lid, ensuring the product is filling the cup's capacity. If product does not escape through the hole, additional product should be added.
4.) Wipe any excess product from the lid.
5.) Place the cup and lid onto the balance and record weight.

### III. Calculation

For purposes of this test specific gravity of the bulk liquid (i.e. liquid detergent) mass of product in cup/83.2 ml.

### Encapsulate Slurry Density Measurement

Follow the protocol for the Bulk Liquid Detergent Density Measurement but substitute the encapsulate slurry for the bulk liquid.

### Encapsulate Density Measurement

Follow the protocol for the Bulk Liquid Detergent Density Measurement but substitute the encapsulate which is obtained by the following protocol:
The density of the microcapsule (encapsulate) is measured from decanted batches, not centrifuged batches. The method is as follows:
The starting slurry comprises 25% solids plus an additional 6% NaCl salt.
The slurry is allowed to decant for 72 hours
The encapsulate cake from the slurry is removed and tested with a density cup
Step 1. Determine the weight of a clean cup in grams at 25° C.
Step 2 Remove cover and fill to within 1.7 mm of rim with material to be tested.
Step 3. Carefully replace cover so that the air and excess material is expelled through vent.
Step 4 Wipe over cover to remove surplus and reweigh. By subtracting the original weight of the cup, the weight of the contents will be found.
   The following relationships apply:
Pounds per U.S. Gallon=Gram Weight of Cup Contents×0.10000
Specific Gravity=Gram Weight of Cup Contents×0.01202
   The encapsulate density is then determined using the data obtained from Steps 1-4 above and the relationships given above.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### Wall Melamine Formaldehyde (MF) Perfume Capsule with High Core Density (≧1)

25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 5.0 with sodium hydroxide solution. 5 grams of partially methylated methylol melamine resin (Cymel 385, 80% solids, (Cytec Industries West Paterson, N.J., U.S.A.)) is added to the emulsifier solution. 150 grams of perfume oil and 50 grams of Brominated Vegetable oil (d=1.3; Virginia Dare, Brooklyn, N.Y., USA) are added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 2

### Wall Melamine Formaldehyde (MF) Perfume Capsule with High Core Density (≧1)

25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 5.0 with sodium hydroxide solution. 5 grams of partially methylated methylol melamine resin (Cymel 385, 80% solids, (Cytec Industries West Paterson, N.J., U.S.A.)) is added to the emulsifier solution. 150 grams of perfume oil and 10 g Tint Ayd PC 9003 (d=2.16, Elementis, Specialities, Hightstones, N.J., USA) are added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 3

### Wall Melamine Formaldehyde (MF) Perfume Capsule with High Core Density (≧1)

25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 5.0 with sodium hydroxide solution. 5 grams of partially methylated methylol melamine resin (Cymel 385, 80% solids, (Cytec Industries West Paterson, N.J., U.S.A.)) is added to the emulsifier solution. 150 grams of perfume oil, 1 gram of Bentone 1000 (d=1.69, Elementis Specialities, Hightstones, N.J., USA) and 15 g Tint Ayd PC 9003 (d=2.16, Elementis, Specialities, Hightstones, N.J., USA) are added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 4

To demonstrate the benefit of the present invention, Applicants prepared liquid detergent matrix A, below.

| Active Material in weight % | A |
|---|---|
| C14-C15 alkyl poly ethoxylate 7 | 3.39 |
| C12-C14 alkyl poly ethoxylate 7 | 1.13 |
| C12-C14 alkyl poly ethoxylate 3 sulfate Na salt | 7.66 |
| Alkylbenzene sulfonic acid | 1.17 |
| Citric Acid | 2.73 |
| C12-18 fatty acid | 5.06 |
| Enzymes | 0.2 |
| Boric Acid | 1.40 |
| Trans-sulphated ethoxylated hexamethylene diamine quat | 0.81 |
| Diethylene triamine penta methylene phosphonic acid | 0.12 |
| Hydrogenated Castor Oil structurant | 0.300 |
| Ethanol | 1.59 |
| 1,2 propanediol | 0.07 |
| Sodium hydroxide | 3.48 |
| Silicone PDMS emulsion | 0.0025 |
| Blue Dye | 0.0006 |
| Preservative Acticide MBS 2550 (ex Thor) | 0.0135 |
| Perfume | Nil |
| Merquat 5300 polymer (1) | 0.19 |
| Water | Up to 95% |

| | A1 | A2 | A3 | A4 | A5 | A6 | A7 | A8 | A9 |
|---|---|---|---|---|---|---|---|---|---|
| Scavenger 1 | — | — | 0.035% | 0.035% | 0.035% | 0.035% | 0.035% | 0.035% | 0.035% |
| Acetoacetamide | | | | | | | | | |
| Scavenger 2 | — | — | — | — | — | — | 0.1 | 0.2 | 0.2 |
| K-sulphite | | | | | | | | | |
| PMCs from | — | 0.3 | 0.3 | 0.3 | — | — | 0.3 | 0.3 | — |
| Example 1 | | | | | | | | | |
| PMCs from | | | | | | | | | |
| Example 2 | | | | | | | | | |
| PMCs from | — | — | — | — | 0.3 | 0.3 | — | — | 0.3 |
| Example 3 | | | | | | | | | |
| Perfume | — | — | — | 0.6 | — | 0.6 | 0.6 | 0.6 | — |
| Water | Up to | Up to | Up to | Up to | Up to | Up to | Up to | Up to | Up to |
| | 100 | 100 | 100 | 100 | 100 | 100 | 100 | 100 | 100 |

(1) Merquat 5300: terpolymer with mole ratio: 90% PAM/5% AA/5% MAPTAC produced by Nalco.

Levels for PMCs from Examples 1 through 3 are expressed as perfume oil or paraffin oil delivered via capsules.

The dimensions and values disclosed herein are not to be understood as being strictly limited to the exact numerical values recited. Instead, unless otherwise specified, each such dimension is intended to mean both the recited value and functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising an encapsulate comprising a core comprising a benefit agent and a shell that at least encapsulates said core, said encapsulate further comprising a density balancing agent, said composition being a consumer product.

2. The composition of claim 1 wherein said encapsulate's benefit agent is selected from the group consisting of a perfume, a dye, optical brightener, fabric care agent, bleaching agent, metal catalyst, bleach booster, solvents, enzyme and mixtures thereof.

3. The composition of claim 1 wherein said encapsulate's density balancing agent is selected from the group consisting of an organic material having a density greater than about 1, an inorganic oxide, inorganic oxy-chloride, inorganic halogenide, a salt, and mixtures thereof.

4. The composition of claim 1 wherein said encapsulate's shell comprises a polymeric water insoluble material selected from the group consisting of polyethylenes, polyamides, polystyrenes, polyisoprenes, polycarbonates, polyesters, polyacrylates, polyureas, polyurethanes, polyolefins, polysaccharides, epoxy resins, vinyl polymers and mixtures thereof.

5. The composition of claim 1, said encapsulate having a density of from about 0.8 to about 1.2.

6. The composition of claim 1 wherein said at least a portion of said density balancing agent is contained in said shell.

7. The composition of claim 1 wherein said core comprises at least a portion of said density balancing agent.

8. The composition of claim 1, wherein said encapsulate is a perfume microcapsule.

9. The composition of claim 1, said composition comprising one or more fluids, said composition having a settling velocity of less than about 1.5 cm/year, less than about 1.0 cm/year.

10. The composition of claim 1 said composition comprising one or more fluids and having a density such that the density ratio of said encapsulate and at least one of said one or more fluids is from about 0.9:1 to about 1.1:1.

11. The composition of claim 10 wherein said encapsulate's density is such that the density ratio of said encapsulate to said one or more fluids is from about 0.9:1 to about 1.1:1.

12. The composition of claims 10 or 11, said composition comprising a cleaning and/or treatment ingredient.

13. The composition of claims 10 or 11 wherein said encapsulate is a perfume microcapsule.

14. The composition of claim 12, wherein said cleaning and/or treatment agent is selected from the group consisting of bleaches, bleach precursors, metal catalysts, bleach boosters, peracids, diacyls, enzymes, and mixtures thereof.
